(19) United States
(12) Patent Application Publication
(10) Pub. No.: US 2010/0115333 A1
(43) Pub. Date: May 6, 2010

(54) DYNAMIC DRIVER LOADING FOR RECOVERY BOOT MEDIA

(76) Inventors: David H. Hanes, Loveland, CO (US); Bryce Carl Wemple, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/261,224

(22) Filed: Oct. 30, 2008

(51) Int. Cl. G06F 11/14; G06F 12/02

(52) U.S. Cl. 714/15; 707/E17.01; 707/E17.044; 714/E11.133

(57) ABSTRACT

In one embodiment a computing device comprises at least one storage media, at least one storage media, a processor, and a memory module comprising logic instructions stored on a computer-readable medium which, when executed by a computer processor, configure the processor to detect, in the computing device, at least one file to support a communication connection with the computing device, store the at least one file on a persistent storage media, and link the at least one file to a restore library.

### BACKGROUND

Computer systems may periodically need to be restored, for example in the event of a crash on a disk drive. Computer systems may periodically update their drivers to accommodate new devices in the network environment. However, in the event that a system restore operation is implemented on the computer system, updates to the drivers available on the computer system will be lost, which potentially reduces the ability of the computer system to interoperate with other devices in the network environment.

### BRIEF DESCRIPTION OF THE DRAWINGS

FIG. 1 is a schematic illustration of one embodiment of computer system, according to embodiments.

FIG. 2 is a flowchart illustrating operations in one embodiment of a method for dynamic driver loading in a network attached storage device, according to embodiments.

FIG. 3 is a flowchart illustrating operations in one embodiment of a method for dynamic driver loading in a network attached storage device, according to embodiments.

### DETAILED DESCRIPTION

Described herein are exemplary systems and methods for dynamic driver loading for recovery boot media which may be implemented in a computer system. The methods described herein may be embodied as logic instructions stored on a computer-readable medium. When executed on a processor, the logic instructions cause a general processor to be programmed as a special-purpose machine that implements the described methods. The processor, when configured by the logic instructions to execute the methods recited herein, constitutes structure for performing the described methods.

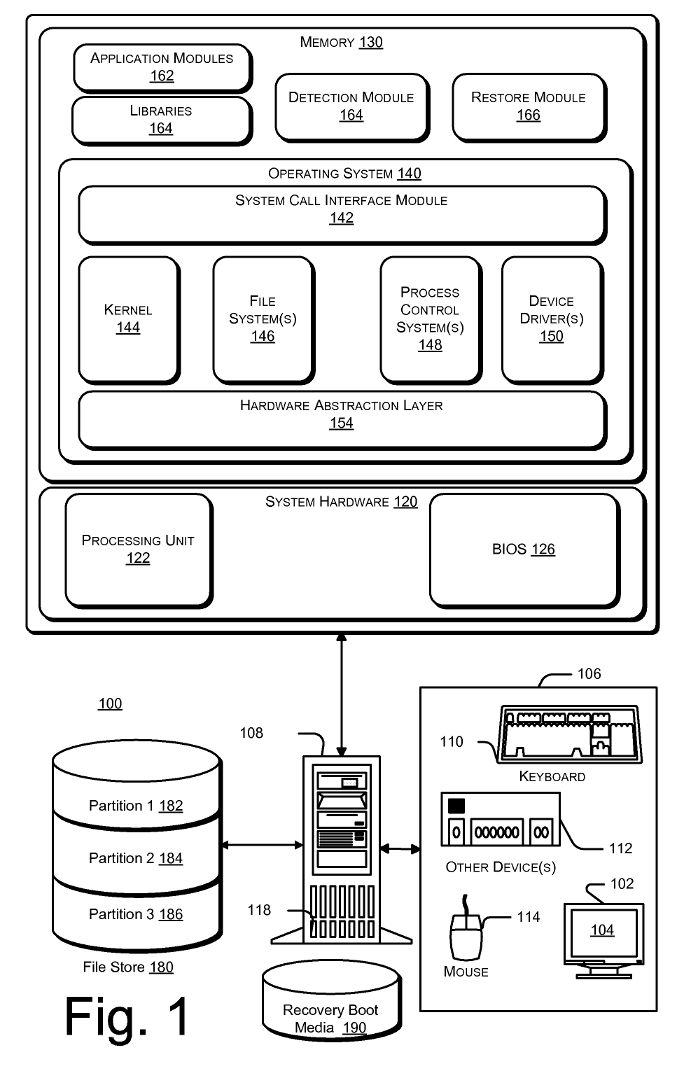

FIG. 1 is a schematic illustration of one embodiment of a computer system adapted to implement dynamic driver loading for recovery boot media, according to an embodiment. In the illustrated embodiment, computer system 100 may be embodied as a hand-held or stationary device for accessing the Internet, a desktop PC, notebook computer, personal digital assistant, or any other processing devices that have a basic input/output system (BIOS) or equivalent.

In the embodiment depicted in FIG. 1, the computer system 100 includes a computer 108 and one or more accompanying input/output devices 106, which may include a display 102 having a screen 104, a keyboard 110, other I/O device(s) 112, and a mouse 114. The other device(s) 112 may include, for example, a touch screen, a voice-activated input device, a track ball, and any other device that allows the system 100 to receive input from a developer and/or a user. The computer 108 includes system hardware 120 including a processing unit 122, and random access memory and/or read-only memory 130. Input/output devices 106 may be coupled to computer 108 by a suitable input/output interface such as, e.g., a universal serial bus (USB) port 118.

A file store 180 is communicatively connected to computer 108. File store 180 may be internal such as, e.g., one or more hard drives, or external such as, e.g., one or more external hard drives, network attached storage, or a separate storage network. File store 180 comprises one or more partitions 182, 184, 186.

Memory 130 includes an operating system 140 for managing operations of computer 108. In one embodiment, operating system 140 includes a hardware abstraction layer 154 that provides an interface to system hardware 120. In addition, operating system 140 includes a kernel 144, one or more file systems 146 that manage files used in the operation of computer 108 and a process control subsystem 148 that manages processes executing on computer 108. Operating system 140 further includes one or more device drivers 150 and a system call interface module 142 that provides an interface between the operating system 140 and one or more application modules 162 and/or libraries 164. The various device drivers 150 interface with and generally control the hardware installed in the computer system 100.

In operation, one or more application modules 162 and/or libraries 164 executing on computer 108 make calls to the system call interface module 142 to execute one or more commands on the computer's processor. The system call interface module 142 invokes the services of the file system(s) 146 to manage the files required by the command(s) and the process control subsystem 148 to manage the process required by the command(s). The file system(s) 146 and the process control subsystem 148, in turn, invoke the services of the hardware interface module 154 to interface with the system hardware 120. The operating system kernel 144 can be generally considered as one or more software modules that are responsible for performing many operating system functions.

The particular embodiment of operating system 140 is not critical to the subject matter described herein. Operating system 140 may be embodied as a UNIX operating system or any derivative thereof (e.g., Linux, Solaris, etc.), a Windows® brand operating system, or any other operating system.

Computer system 100 further includes a basic input/output system (BIOS) 126. In one embodiment, BIOS 126 may be implemented in flash memory and may comprise a power-on self-test (POST) module for performing system initialization and tests. In operation, when activation of computer system 100 begins, processing unit 122 accesses BIOS 126 and shadows the instructions of BIOS 126, such as power-on self-test module, into operating memory. Processor 122 then executes power-on self-test operations to implement POST processing.

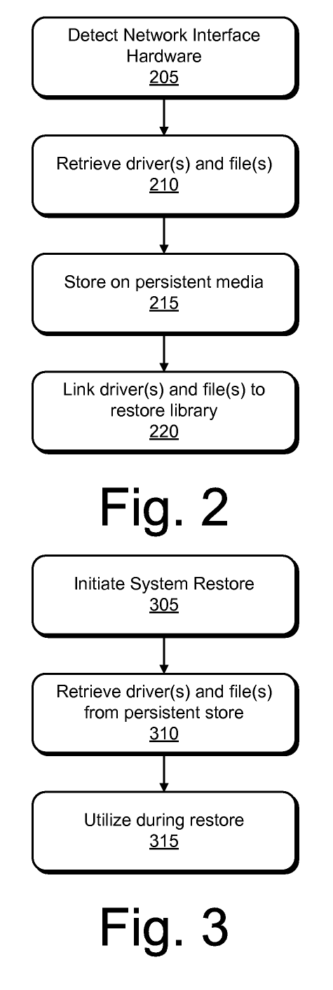

In some embodiments, memory 130 includes a detection module 164 and a restore module 166 to implement dynamic driver loading for recovery boot media. In the embodiment depicted in FIG. 1, portions of detection module 164 and a restore module 166 are stored in association with BIOS 126. In alternate embodiments, access management module 128 may be stored in other memory modules associated with computer system 108. Operations implemented by some embodiments of detection module 164 and restore module 166 are described with reference to FIG. 2 and FIG. 3.

FIG. 2 is a flowchart illustrating operations in one embodiment of a method for dynamic driver loading in a network attached storage device, according to embodiments. In some embodiments, the operations depicted in FIG. 2 are implemented by the detection module 164. In some embodiments the operations of FIG. 2 may be initiated manually, e.g., by an input from a user of the computer system 100. In alternate embodiments the operations of FIG. 2 may be initiated automatically, e.g., at a specified time or in response to an event.

Referring to FIG. 2, at operation 205, detection module 164 detects one or more network interface hardware devices in the computer system 100. In some embodiments, detecting one or more network interface hardware devices in the computer system 100 comprises detecting a network interface card driver associated with the computing device.

At operation 210, detection module 164 retrieves driver(s) and other file(s) necessary to communication via the detected network interface hardware devices detected in operation 205. In some embodiments, the drivers and other file(s) may be retrieved from the computing device. In alternate embodiments the driver(s) may be retrieved from a remote source. For example, the detection module 164 may retrieve information identifying the computing device, then use the information to retrieve the driver(s) and other files from a remote source, e.g., from the manufacturer of the device via the Internet.

Once the driver(s) and other file(s) have been retrieved, they are stored on a persistent storage media. In some embodiments, the driver(s) and file(s) may be stored on a portion of the storage media 180 managed by the network attached storage device. By contrast, in some embodiments, the driver(s) and file(s) may be stored on an external storage media, e.g., a recover boot media 190 such as a recordable CD-ROM, a magnetic storage media, or an NV-RAM device.

At operation 220 the driver(s) and file(s) are linked to a restore library. By way of example, the driver(s) and file(s) may be logically linked to a library used by a restore application during a restore operation for the network attached storage device.

FIG. 3 is a flowchart illustrating operations in one embodiment of a method for dynamic driver loading in a computer system 100, according to embodiments. In some embodiments, the operations depicted in FIG. 3 are implemented by the restore module 166 during a restore operation of the computer system 100.

At operation 305 a system restore procedure is initiated. In some embodiments, the system restore procedure may be initiated by a user of the computer system 100, typically in response to a failure of a component (e.g., a hard drive) of the computer system 100.

At operation 310 the driver(s) and file(s) stored on the persistent storage media are retrieved, and at operation 315 the driver(s) and file(s) are utilized on the computer system 100 during the restore operation.

Some embodiments may be provided as computer program products, which may comprise a machine-readable or computer-readable medium having stored thereon instructions used to program a computer (or other electronic devices) to perform a process discussed herein. The machine-readable medium may comprise, but is not limited to, floppy diskettes, hard disk, optical disks, CD-ROMs, magneto-optical disks, ROMs, RAMs, erasable programmable ROMs (EPROMs), electrically erasable EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Reference in the specification to “one embodiment” or “an embodiment” means that a particular feature, structure, or characteristic described in connection with the embodiment is comprised in at least an implementation. The appearances of the phrase “in one embodiment” in various places in the specification are not necessarily all referring to the same embodiment.

What is claimed is:

1. A method for dynamic driver loading in a computing device, comprising:
detecting, in the computing device, at least one file to support a communication connection with the computing device;
storing the at least one file on a persistent storage media; and
linking the at least one file to a restore library.

2. The method of claim 1, wherein detecting, in the computing device, at least one file to support a communication connection with the computing device comprises detecting at least one network interface hardware device associated with the computing device.

3. The method of claim 1, wherein storing the at least one file on a persistent storage media comprises storing the at least one file on a restore media.

4. The method of claim 1, wherein storing the at least one file on a persistent storage media comprises storing the at least one file on a non-volatile memory device.

5. The method of claim 1, further comprising:
initiating a system restore operation on the computing device;
retrieving the at least one data file from the persistent storage media during a restore operation; and
utilizing the at least one data file on the computing device.

6. A computer program product comprising logic instructions stored on a computer-readable medium which, when executed by a computer processor, configure the processor to:
detect, in the computing device, at least one file to support a communication connection with the computing device;
store the at least one file on a persistent storage media; and
link the at least one file to a restore library.

7. The computer program product of claim 6, further comprising logic instructions stored on a computer-readable medium which, when executed by a computer processor, configure the processor to detect at least one network interface hardware device associated with the computing device.

8. The computer program product of claim 6, further comprising logic instructions stored on a computer-readable medium which, when executed by a computer processor, configure the processor to store the at least one file on a restore media.

9. The computer program product of claim 6, further comprising logic instructions stored on a computer-readable medium which, when executed by a computer processor, configure the processor to store the at least one file on a non-volatile memory device.

10. The computer program product of claim 6, further comprising logic instructions stored on a computer-readable medium which, when executed by a computer processor, configure the processor to:
initiate a system restore operation on the computing device;
retrieve the at least one data file from the persistent storage media during a restore operation; and
utilizing the at least one data file on the computing device.

11. A computing device, comprising:
at least one storage media;
a processor; and
a memory module comprising logic instructions stored on a computer-readable medium which, when executed by a computer processor, configure the processor to:
detect, in the computing device, at least one file to support a communication connection with the computing device;
store the at least one file on a persistent storage media; and
link the at least one file to a restore library.

12. The computing device of claim 11, further comprising logic instructions stored on a computer-readable medium which, when executed by a computer processor, configure the processor to detect one or more network interface card drivers of the computing device.

13. The computing device of claim 11, further comprising logic instructions stored on a computer-readable medium which, when executed by a computer processor, configure the processor to store the at least one file on a restore media.

14. The computing device of claim 11, further comprising logic instructions stored on a computer-readable medium which, when executed by a computer processor, configure the processor to store the at least one file on a non-volatile memory device.

15. The computing device of claim 11, further comprising logic instructions stored on a computer-readable medium which, when executed by a computer processor, configure the processor to:
initiate a system restore operation on the computing device;
retrieve the at least one data file from the persistent storage media during a restore operation; and
utilize the at least one data file on the computing device.
